(19) United States
(12) Patent Application Publication
(10) Pub. No.: US 2005/0238327 A1
(43) Pub. Date: Oct. 27, 2005

(54) Recording apparatus, visible image forming method, recording medium and computer data signal

(76) Inventors: Hiroki Sugahara, Kanagawa (JP); Ichiro Moritomo, Kanagawa (JP); Hirotsugu Sato, Kanagawa (JP); Mitsuyuki Kobayashi, Kanagawa (JP); Yoshihiko Hotta, Shizuoka (JP); Yoshiko Nakata, Chiba (JP); Yukiko Inada, Tokyo (JP)

Correspondence Address: MORRISON & FOERSTER LLP, 1650 TYSONS BOULEVARD, SUITE 300, MCLEAN, VA, 22102, US

(21) Appl. No.: 11/109,865

(22) Filed: Apr. 20, 2005

(30) Foreign Application Priority Data
Apr. 20, 2004 (JP) 2004-124291

(51) Int. Cl. H04N 5/781

(52) U.S. Cl. 386/95; 386/126

(57) ABSTRACT

A recoding apparatus includes an optical recording device that optically records information on an optical disk and an image forming apparatus that forms an image on a thermosensitive medium provided on the optical disk. When a moving image of a TV broadcast program is recorded on the optical disk by the optical recording device, it is possible to obtain information of TV broadcast such as a TV broadcast itself, an electronic program guide and the like, information held by the present recording apparatus or information relating to the program recorded by the optical recording device from information recorded on the optical disk. Then, the obtained information is image-formed on the thermosensitive medium provided on the optical disk by the image forming device.

### BACKGROUND OF THE INVENTION

1. Field of the Invention

The present invention relates to a recording apparatus that can form a visible image for helping a user visually recognize program contents recorded on an optical disk on a non-recording surface of the optical disk, visible image forming method, recording medium, and computer data signal.

2. Description of the Related Art

Unexamined Japanese Patent Application KOKAI Publication No. H8-318634 discloses techniques relating to a thermosensitive medium (reversible thermosensitive medium) that can repeatedly form and erase a visible image by heat and an image forming apparatus (rewritable recording apparatus) that forms and erases the visible image on and from the thermosensitive medium.

While, in a DVD recorder and a personal computer with a DVD drive, it is possible to record a TV broadcast program (image and voice) on a writable DVD. Then, a user intends to recognize the broadcast program recoded on the DVD by handwriting a program name on a label surface of the DVD.

However, such work was complicated for the user and there was difficulty in recognizing the content of the broadcast program recorded on the DVD from the handwritten program name. For this reason, it was desired that the DVD recorder and the personal computer should automatically print information indicating the content of the broadcast program on the label surface of DVD. For example, it is considered that the aforementioned thermosensitive medium is provided on the label surface of DVD and that a visible image indicating the content of the broadcast program is formed on the thermosensitive medium.

However, since a range where the visible image can be formed was narrow on the label surface of DVD, there was need to select information enough to indicate the content of the broadcast program to form a suitable visible image.

### SUMMARY OF THE INVENTION

An object of the present invention is to provide a recording apparatus that can form a visible image for helping a user visually recognize program contents recorded on an optical disk on a non-recording surface of the optical disk, visible image forming method, recording medium, and computer data signal.

In order to attain the above object, a recording apparatus according to a first aspect of the present invention includes a recording section that records a broadcast program including an image and voice on a recording surface of an optical disk. The recording apparatus further includes an obtaining section that obtains program information relating to the broadcast program recorded by the recording section. The recording apparatus further includes a reading section that reads predetermined information from the optical disk on which the broadcast program is recorded. The recording apparatus further includes a generation section that generates content information indicating contents of the broadcast program recorded on the optical disk from information read by the reading section. The recording apparatus further includes a forming section that forms a visible image on a non-recording surface of the optical disk based on content information generated by the generation section.

According to the present invention, the recording section records the broadcast program including an image and voice on the recording surface of an optical disk. The obtaining section obtains program information relating to the broadcast program recorded by the recording section. The reading section reads predetermined information from the optical disk on which the broadcast program is recorded. The generation section generates content information indicating contents of the broadcast program recorded on the optical disk from information read by the reading section. Then, the forming section forms a visible image on a non-recording surface of the optical disk based on content information generated by the generation section.

As a result, it is possible to form a visible image for helping a user visually recognize program contents recorded on the optical disk on a non-recording surface of the optical disk.

The forming section may form the visible image onto a thermosensitive medium provided on the non-recording surface of the optical disk.

The forming section may form a new visible image after erasing the formed visible image when the visible image is formed on a reversible thermosensitive medium provided on the non-recording surface of the optical disk.

The generation section may generate content information including at least any of items of a program name, a recording date, a picture mode, a typical image, a recorded time, a remaining time for recording, a genre name, a performer name, a program explanation, and a kind of optical disk.

The generation section may generate content information that specifies a range where the visible image can be formed and sets a character size to be contained in the specified range.

The generation section may generate content information that specifies a range where the visible image can be formed and limits the number of characters to be contained in the specified range.

The forming section may generate content information of the preset number of broadcast programs when multiple broadcast programs are recorded on the optical disk.

The forming section may select broadcast programs corresponding to only the set number based on the recording date to generate content information, and add the number of broadcast programs that are omitted in selection to content information.

The forming section may select an item based on the number of programs and a preset priority to generate content information including the selected item when multiple broadcast programs are recorded on the optical disk.

The forming section may generate content information including at least a single program name and each recording date when multiple different episodes of the same broadcast program are recorded on the optical disk.

The recording apparatus may further include a reproducing section that reproduces a broadcast program recorded on the optical disk. The forming section may specify the broadcast program generated by the reproducing section to generate content information including information indicating that the specified broadcast program is already viewed.

In order to attain the above object, a recording apparatus according to a second aspect of the present invention comprises:
recording means for recording a broadcast program including an image and voice on a recording surface of an optical disk;
obtaining means for obtaining program information relating to the broadcast program recorded by the recording means;
reading means for reading predetermined information from the optical disk on which the broadcast program is recorded;
generating means for generating content information indicating a content of the broadcast program recorded on the optical disk from program information obtained by the obtaining means and information read by the reading means; and
forming means for forming a visible image on a non-recording surface of the optical disk based on content information generated by the generating means.

According to the present invention, the recording means for recording a broadcast program including an image and voice on a recording surface of an optical disk. The obtaining means for obtaining program information relating to the broadcast program recorded by the recording means. The reading means for reading predetermined information from the optical disk on which the broadcast program is recorded. The generating means for generating content information indicating contents of the broadcast program recorded on the optical disk from program information obtained by the obtaining means and information read by the reading means. Then, the forming means for forming a visible image on a non-recording surface of the optical disk based on content information generated by the generating means.

As a result, it is possible to form a visible image for helping a user visually recognize program contents recorded on the optical disk on a non-recording surface of the optical disk.

In order to attain the above object, a visible image forming method according to a third aspect of the present invention records a broadcast program including an image and voice on a recording surface of an optical disk. The visible image forming method further obtains program information relating to the broadcast program recorded by the recording. The visible image forming method further reads predetermined information from the optical disk on which the broadcast program is recorded. The visible image forming method further generates content information indicating contents of the broadcast program recorded on the optical disk from information read by the reading. The visible image forming method further forms a visible image on a non-recording surface of the optical disk based on content information generated by the generating.

According to the present invention, the recording records a broadcast program including an image and voice on a recording surface of an optical disk. Moreover, the obtaining obtains program information relating to the broadcast program recorded by the recording. The reading reads predetermined information from the optical disk on which the broadcast program is recorded. The generating generates content information indicating contents of the broadcast program recorded on the optical disk from information read by the reading. Then, the forming forms a visible image on a non-recording surface of the optical disk based on content information generated by the generating.

As a result, it is possible to form a visible image for helping a user visually recognize program contents recorded on the optical disk on a non-recording surface of the optical disk.

In order to attain the above object, a recording medium according to a fourth aspect of the present invention has a program recorded thereon. The program causes a computer to execute a visible image forming method. The visible forming method records a broadcast program including an image and voice on a recording surface of an optical disk. The visible forming method further obtains program information relating to the broadcast program recorded by the recording. The visible forming method further reads predetermined information from the optical disk on which the broadcast program is recorded. The visible forming method further generates content information indicating contents of the broadcast program recorded on the optical disk from program information obtained by the obtaining and information read by the reading. The visible forming method further forms a visible image on a non-recording surface of the optical disk based on content information generated by the generating.

To achieve the objects, according to the fifth aspect of the invention, there is provided a computer data signal embedded in a carrier wave, representing a program for controlling a computer to execute: recording a broadcast program including an image and voice on a recording surface of an optical disk; obtaining program information relating to the broadcast program recorded by the recording; reading predetermined information from the optical disk on which the broadcast program is recorded; generating content information indicating a content of the broadcast program recorded on the optical disk from program information obtained by the obtaining and information read by the reading; and forming a visible image on a non-recording surface of the optical disk based on content information generated by the generating.

### BRIEF DESCRIPTION OF THE DRAWINGS

These objects and other objects and advantages of the present invention will become more apparent upon reading of the following detailed description and the accompanying drawings in which:

FIG. 1 is a schematic view illustrating one example of a configuration of an optical disk according to an embodiment of the present invention;

FIG. 2 is a block diagram illustrating one example of a configuration of a recording apparatus;

FIG. 3 is a block diagram illustrating one example of another configuration of a recording apparatus;

FIG. 4 is a flowchart for explaining an operation of a recording apparatus;

FIG. 5 is a flowchart for explaining an operation of a recording apparatus;

FIG. 6 is a flowchart for explaining an operation of a recording apparatus; and

FIG. 7 is an explanatory view of one example in which an image is formed on an optical disk by a recording apparatus.

### DETAILED DESCRIPTION OF THE PREFERRED EMBODIMENT

The following will explain a recording apparatus according to an embodiment of the present invention with reference to the drawings. The recording apparatus records a broadcast program (image and voice) on a recording surface of an optical disk and forms a visible image indicating program contents on a non-recording surface of the optical disk.

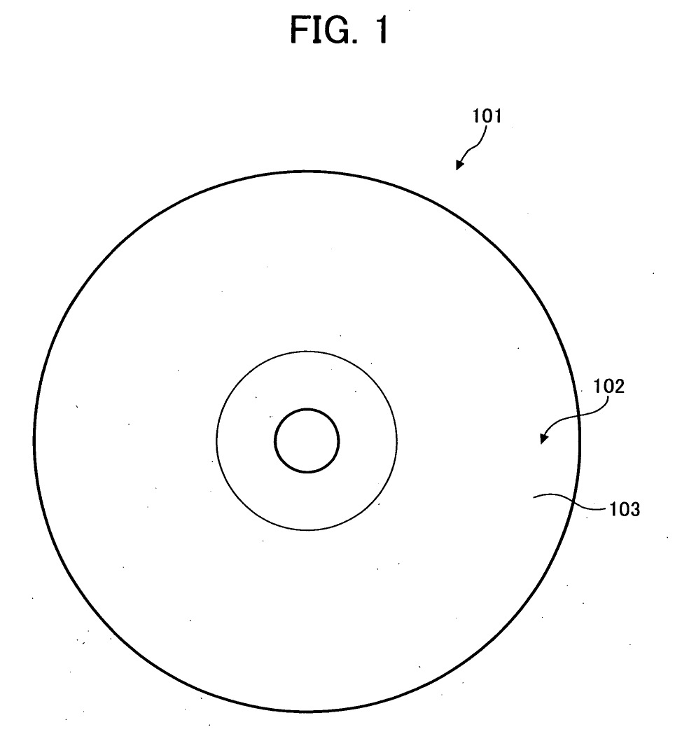

FIG. 1 is a plane view of a non-recording surface (label surface) of an optical disk 101 applied to the embodiment of the present invention.

The optical disk includes, for example, a writable DVD (DVD−R, DVD+R, DVD−RW, DVD+RW, DVD-RAM) and has a recording surface on an opposite side (back side) to allow information with a predetermined capacity to be recorded. Additionally, the optical disk 101 may be a writable CD (CD-R, CD-RW).

Moreover, a label surface has a thermosensitive medium 103 on which a visible image such as a character and an image can be formed by heat.

As the thermosensitive medium 103, it is possible to use either one (direct thermal) on which a visible image can be formed only one time or one (thermal rewritable) on which the visible image is rewritable.

For example, when a reversible thermosensitive medium (thermal rewritable) is used as the thermosensitive medium 103, the visible image can be repeatedly formed and erased by heat.

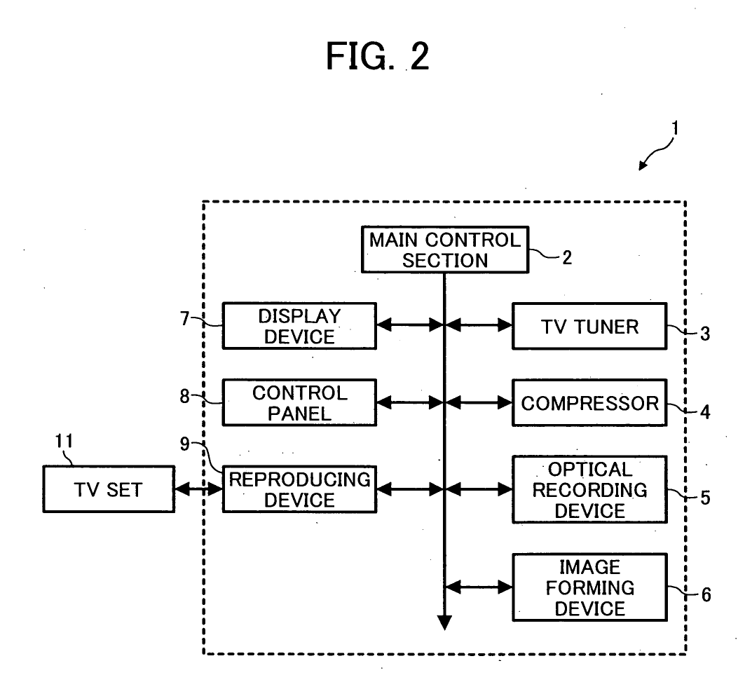

FIG. 2 is a block diagram illustrating one example of a recording apparatus 1 applied to the embodiment of the present invention. The recording apparatus 1 indicates, for example, a DVD recorder connected to a TV set 11 such as a TV monitor.

As illustrated in the figure, the recording apparatus 1 includes a main control section 2, a TV tuner 3, a compressor 4, an optical recording device 5, an image forming device 6, a display device 7, a control panel 8, and a reproducing device 9.

The main control section 2 includes a microcomputer and the like and controls the entirety of the recording apparatus 1.

The TV tuner 3 receives a broadcast program (broadcast signal) of, for example, analog and digital terrestrial broadcasting, satellite broadcasting, and cable broadcasting. Additionally, the TV tuner 3 also receives program information including a program name, a program explanation, etc.

The compressor 4 compresses and codes an image and voice of the broadcast program received by the TV tuner 3 in MPEG-2 format.

The optical recording device 5 records information (broadcast program, etc) compressed and coded by the compressor 4 on a recording surface of the optical disk 101.

The image forming device 6 includes, for example, a thermal head, and forms a visible image such as a character and an image on the thermosensitive medium 103 of the optical disk 101 by heat.

The display device 7 includes a liquid crystal panel and the like and displays various kinds of messages.

The control panel 8 receives various kinds of operations from a user.

The reproducing device 9 displays a broadcast program, which is received by the TV tuner 3, and a broadcast program, which is obtained by reproducing the optical disk 101, on the TV set 11.

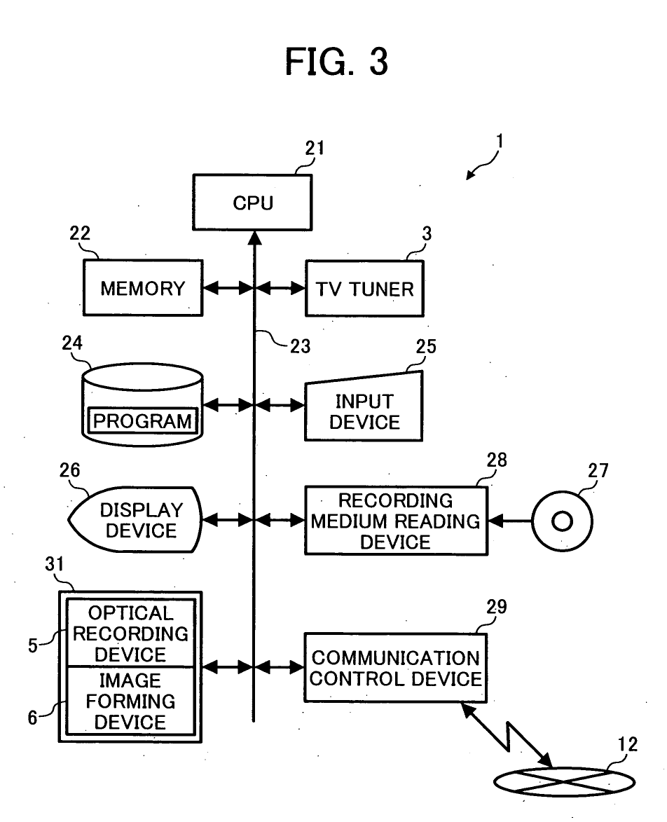

FIG. 3 is a block diagram illustrating one example of a configuration of another recording apparatus 1. This recording apparatus 1 indicates a personal computer having an optical disk drive as one example.

As illustrated in the figure, the recording apparatus I includes a TV tuner 3, a CPU 2 1, a memory 22, a magnetic storage device 24, an input device 25, a display device 26, a recording medium reading device 28, a communication control device 29, and an optical disk drive device 31, and the respective components are connected to one another via a bus 23.

The TV tuner 3 includes a tuner unit and the like, and receives a broadcast program (broadcast signal) in the same way as mentioned above.

The CPU 21 performs various kinds of operations and intensively controls each section.

The memory 22 includes ROM, RAM, and the like, and stores various kinds of information.

The magnetic storage device 24 includes a hard disk and the like, and stores a program 30.

The input device 25 includes a keyboard, a mouse, and the like, and inputs predetermined instruction information according to a user's operation.

The display device 26 includes a monitor and the like, and displays an image indicating an operational state of the recording apparatus 1 and a broadcast program reproduced by the optical disk drive device 31.

The recording medium reading device 28 reads information stored in a recording medium 27 including CD and the like. Additionally, the optical disk drive device 31 may read information stored in the storage medium 27 without providing the recording medium reading device 28.

The communication control device 29 includes a modem, an LAN card, and the like and controls communication with another apparatus via a network 12 such as the Internet.

The optical disk drive device 31 includes the aforementioned optical recording device 5 and the image forming device 6. Namely, the optical disk drive device 31 records the broadcast program on a recording surface of the optical disk 101 using the optical recording device 5 and forms a visible image on the thermosensitive medium 103 of the optical disk 101 using the image forming device 6. Additionally, the optical disk drive device 31 also reproduces the broadcast program recorded on the optical disk 101.

The above-configured recoding apparatus 1 reads the program 30 stored in the stored medium 27 and installs the program on the magnetic storage device 24. Moreover, the recording apparatus 1 may download the program 30 via the network 12 to install the program on the magnetic storage device 24.

When the program 30 is installed, the recording apparatus 1 can execute recoding processing as described later. In other words, the recording apparatus 1 executes recording processing, thereby controlling the optical disk drive device 31 to record the broadcast program on the recording surface of the optical disk 101 and to form the visible image indicating the program contents on the thermosensitive medium 103 of the optical disk 101. In addition to this, the recording apparatus 1 performs control to display the broadcast program received by the TV tuner 3 and the broadcast program recorded on the optical disk 101 reproduced by the optical disk drive device 31.

Additionally, the program 30 may be operated on a predetermined OS.

In the aforementioned recording apparatus 1, for example, the optical disk 101 is mounted on a tray (not shown) with the label surface 102 directed upward to be contained in the apparatus. Then, the optical recording device 5 can record the broadcast program on the recording surface from the lower side, of the optical disk 101. Moreover, the image forming apparatus 6 can form the visible image on the thermosensitive medium 103 from the upper side of the optical disk 101 by heat.

The following will explain an operation of the recording apparatus 1 with reference to the drawings. Specifically, the explanation will be given of a case in which the broadcast program is recorded on the recording surface of the optical disk 101 and the visible image indicating the program contents is formed on the thermosensitive medium 103 of the optical disk 101.

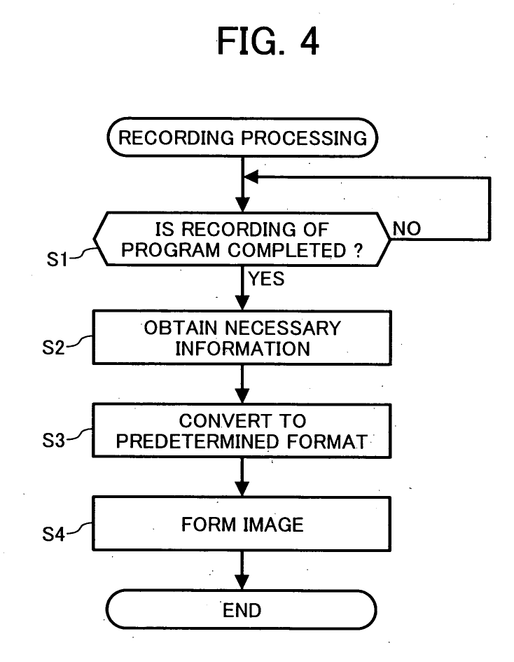

FIG. 4 is a flowchart for explaining recording processing executed by the recording apparatus 1. The recording processing is started when the user provides instructions for recording a predetermined broadcast program on the optical disk 101.

First of all, the recording apparatus 1 waits for the recording to be completed while recording the broadcast program on the optical disk 101 (recording surface) (step S1). For example, the recording apparatus 1 waits for the recording of one program to be completed. Additionally, when multiple programs are continuously recorded, the recording apparatus 1 waits for the recording of all programs to be completed.

Then, when the recording is completed, the recording apparatus 1 obtains necessary data from image data of the program received by the TV tuner 3, data of a program table (EPG: Electric Program Guide) and data held by the recording apparatus 1 (step S2). Information obtained here is information relating to the broadcast program recorded on the optical disk 101 in step S1. Then, the recording apparatus 1 converts the obtained information to image data of a predetermined formatted image (step S3). The image forming device 6 forms an image on the thermosensitive medium 103 based on the converted imaged data (step S4).

By the way, there is a case in which another program is additionally recorded on the optical disk 101 after a certain broadcast program is recorded thereon. In this case, when the image is formed (printed) on the thermosensitive medium 103 only one time by the image forming device 6, it is necessary to determine to which part of the thermosensitive medium 103 the printing is performed at the previous time. Then, information of a new program must be printed on a part after the previously printed part.

On the other hand, if the thermosensitive medium 103 is rewritable by the image forming device 6, the previously printed portion is erased and information for the previous program and information for the current program may be printed from the beginning, thereby eliminating the need of determining whether to which part of the thermosensitive medium 103 the printing is performed at the previous time.

In this case, a file in which information to be printed on the thermosensitive medium 103 is recorded on the recording surface of the optical disk 101 in addition to the image of the program. This is useful to reprint information for a previous program and information for a current program from the beginning by reading the file in connection with content information, which relates to the previously recorded program onto the thermosensitive medium 103. Additionally, it is not essential to record such the file on the recording surface of the optical disk. This is because information of the previous program itself is recorded on the optical disk 101 to make it possible to read information necessary for printing from information of this program. Accordingly, a source for information to be recorded on the thermosensitive medium 103 is any one of information of the TV broadcast program itself, information of the TV broadcasting such as EPG information, information held by the recording apparatus 1 and information recorded on the optical disk 101.

Additionally, the standards of the recording apparatuses are desirably unified in order that the file of program information previously recorded on the optical disk 101 can be used in common to different manufactures of the recording apparatus 1 and information of the file can be correctly recognized even if the optical disk 101 is mounted on the recording apparatus 1 of a different manufacture.

Furthermore, though only one printing to the thermosensitive medium 103 can be executed as mentioned above, it is considered that the recording to the thermosensitive medium 103 in this case is executed when a session is closed in recording to the optical recording surface of DVD−R or DVD+R, which is the optical disk 101. Though session closing makes it impossible to execute additional recording, reproduction becomes possible.

The following will specifically explain processing in step S2 and the following steps.

First of all, an explanation will be specifically given of processing (step S2) for obtaining necessary information. Information to be obtained includes the following contents and serves as display information.

Program Name

A “program name” can be obtained from EPG data.

Recording Date

This is data of recording year, month, and day. In the case where a TV program on the air is recorded in real time, a “recording date” can be obtained from EPG data, and can be obtained from a timer built in the recording apparatus 1.

Picture Mode

This is information of a mode relating to an image quality such as a “triple mode”, a “standard mode” and the like that is set by the user at the time of recording. Since the user sets a picture mode using the recording apparatus 1, information is held by the recoding apparatus 1.

Program Image

This is one frame image of a recorded moving image. The program image can be obtained from moving image data of a program to be recorded. For example, one frame of an image may be extracted and used at the time when a fixed time passes after the program is started.

Owner Name

This is an owner name of the optical disk 101. The owner name is preregistered in the recording apparatus 1 and the registered data can be used.

Remaining Time for Recording

This can be judged from the residual storage capacity of the optical disk 101. It is noted that the “remaining time for recording” differs depending on the “picture mode”, so that the remaining time must be displayed for each “picture mode” as in “triple mode: 30 minutes”, “standard mode: 10 minutes.”

Performer Name

This can be obtained from EPG data.

Program Explanation

This can be also obtained from EPG data.

Genre Name

This is a genre name of the recorded program, namely, names of “sports”, “move”, “news” and the like. The genre name can be obtained from EPG data.

Recorded Time

This is time of the recorded program and is displayed as in “30 minutes”, “60 minutes.” The recorded time can be judged from the timer built in the recording apparatus 1.

Kind of Optical Disk

This is information indicating that the kind of optical disk 101 on which the program is recorded is any one of DVD−R, DVD+R, DVD-RAM, and DVD−RW. The recording apparatus 1 reads the kind of optical disk from the optical disk 101 and holds the kind of optical disk before recording to the optical disk 101 is started. In the case of DVD-RAM, “RAM” may be displayed. In the case of DVD−RW, “RW” may be displayed.

An explanation will be given of processing (step S3) for converting information obtained in step S2 to image data of a predetermined formatted image. Namely, this processing executes selection of data displayed as explained below.

(1) First of all, when there are multiple programs to be recorded on the optical disk 101, only information of the preset number of latest programs is selected and displayed. Regarding the other programs, only the number of programs is displayed. It is determined by the “recorded date” to which is the latest program.

(2) Priority is preset to other display information of the aforementioned “program name”, and display information is selected according to the number of programs to be displayed. In other words, display information is deleted in order of ascending the set priority as the number of displaying programs is increased. More specifically, since there is a limitation in a range where the image can be formed on the thermosensitive medium 103 of the optical disk 101, display information is selected from the number of characters to be printed.

(3) Since there is the limitation in the range where the image can be formed on the thermosensitive medium 103 of the optical disk 101, a character size to be used in printing is selected from the number of characters to be printed. Namely, the more the number of characters to be printed is increased, the smaller the selecting character size is selected.

(4) There is a case in which images of multiple different episodes of the same program are recorded on one optical disk 101. In this case, since the “program name” is common to all, the single “program name” is displayed, and “recording date” of each episode is displayed together with the single “program name.”

Then, the above-converted data is image-formed on the thermosensitive medium 103 by the image forming apparatus 6 (step S4).

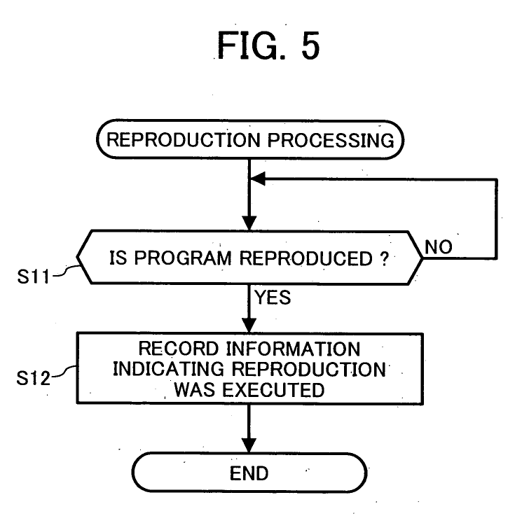

Moreover, when the optical disk 101 recorded in this way is reproduced by the recording apparatus 1, reproduction processing as in FIG. 5 is executed.

First of all, when reproducing a certain program recorded on the optical disk 101 (step S11; Yes), the recording apparatus 1 adds information such as a character of “viewed” indicating that reproduction was executed to a column where display information such as a “program name” and executes printing after the end of the reproduction (step S12).

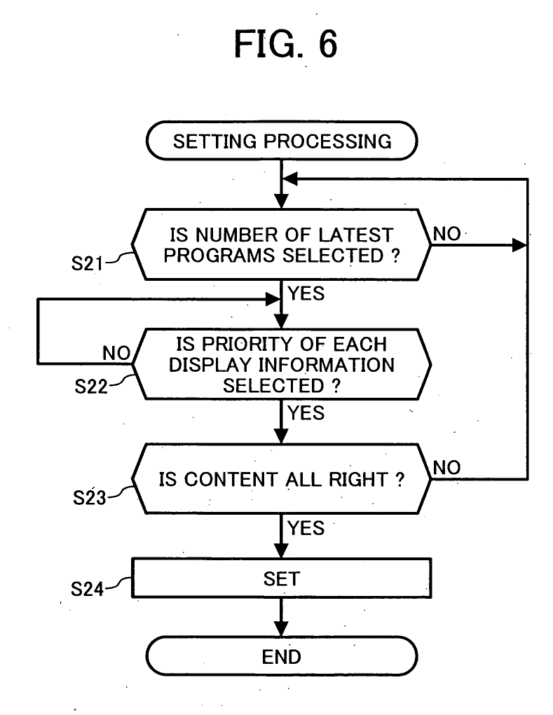

FIG. 6 is a flowchart explaining setting processing that is executed in advance by the user to perform recording processing.

First of all, when the number of programs to be recorded on the optical disk 101 is multiple, the number of the latest programs is selected at the time of selecting and displaying information of only the latest programs (step S21; Yes). In this example, it is assumed that setting is made in such way that information of only two latest programs is selected and displayed. Moreover, priority put to each display information is selected (step S22; Yes). In this example, it is assumed that the importance of information is divided into three levels, namely, “program name” and “recording date” are the most important information, “picture mode”, “program image”, “owner name”, and “kind of optical disk” are important information, and “remaining time for recording”, “performer”, “program explanation”, “genre name”, and “recorded time” are general information. Then, if the content is all right (step S23; Yes), the content is set (step S24) and the set content is recorded in an involatile memory. In addition to this, setting as to whether the aforementioned recording processing should be executed may be carried out.

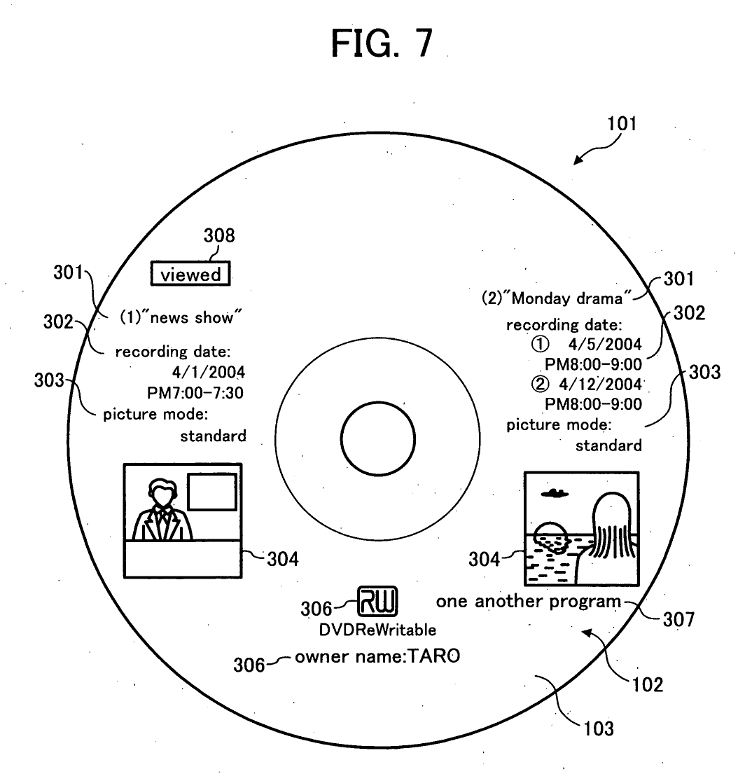

FIG. 7 is a schematic view illustrating one example of the image formed on the thermosensitive medium 103 by the image forming apparatus 6 in the aforementioned recording processing. In this example, four programs are recorded. However, since information of only two programs is selected and displayed in step S21, information of only two programs shown in (1) and (2) of the figure is printed. Then, the importance of information is divided into three levels, namely, “program name” and “recording date” are the most important information, “picture mode”, “program image”, “owner name”, and “kind of optical disk” are important information, and “remaining time for recording”, “performer“, “program explanation”, “genre name”, and “recorded time” are general information in step S22. Accordingly, in this embodiment, regarding “remaining time for recording”, “genre name”, and “recorded time” that are set as a general importance, printing is omitted. Regarding each of two programs shown in (1) and (2), a program name 301, a recording date 302, a picture mode 303, and a program image 304 are respectively printed, and an owner name 305 and a kind of optical disk 306 are also printed. Furthermore, regarding the program shown in (2), since broadcast for two episodes of the program shown in (2) is recorded, the recording date 302 for two episodes is printed, and a character 307 indicating that there is one another program is printed for one program with no program name.

Moreover, when the user reproduces the recorded program later, a character 308 indicating “viewed” is printed by reproduction processing of FIG. 5 in connection with the reproduced program.

As explained above, it is possible to form a visible image for helping a user visually recognize the program content recorded on an optical disk on a non-recording surface of the optical disk.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2004-124291 filed on Apr. 20, 2004 and including specification, claims, drawings and summary. The disclosure of the above Japanese Patent Application is incorporated herein by reference in its entirety.

1. A recording apparatus comprising:
a recording section that records a broadcast program including an image and voice on a recording surface of an optical disk;
an obtaining section that obtains program information relating to the broadcast program recorded by said recording section;
a reading section that reads predetermined information from the optical disk on which the broadcast program is recorded;
a generation section that generates content information indicating a content of the broadcast program recorded on the optical disk from information read by said reading section; and
a forming section that forms a visible image on a non-recording surface of the optical disk based on content information generated by said generation section.

2. The recording apparatus according to claim 1, wherein said forming section forms the visible image onto a thermosensitive medium provided on the non-recording surface of the optical disk.

3. The recording apparatus according to claim 1, wherein said forming section forms a new visible image after erasing the formed visible image when the visible image is formed on a reversible thermosensitive medium provided on the non-recording surface of the optical disk.

4. The recording apparatus according to claim 1, wherein said generation section generates content information including at least any of items of a program name, a recording date, a picture mode, a typical image, a recorded time, a remaining time for recording, a genre name, a performer name, a program explanation, and a kind of optical disk.

5. The recording apparatus according to claim 1, wherein said generation section generates content information that specifies a range where the visible image can be formed and sets a character size to be contained in the specified range.

6. The recording apparatus according to claim 1, wherein said generation section generates content information that specifies a range where the visible image can be formed and limits the number of characters to be contained in the specified range.

7. The recording apparatus according to claim 1, wherein said forming section generates content information of the preset number of broadcast programs when multiple broadcast programs are recorded on the optical disk.

8. The recording apparatus according to claim 7, wherein said forming section selects broadcast programs corresponding to only the set number based on the recording date to generate content information, and adds the number of broadcast programs that are omitted in selection to content information.

9. The recording apparatus according to claim 1, wherein said forming section selects an item based on the number of programs and a preset priority to generate content information including the selected item when multiple broadcast programs are recorded on the optical disk.

10. The recording apparatus according to claim 1, wherein said forming section generates content information including at least a single program name and each recording date when multiple different episodes of the same broadcast program are recorded on the optical disk.

11. The recording apparatus according to claim 1, further comprising a reproducing section that reproduces a broadcast program recorded on the optical disk, wherein said forming section specifies the broadcast program generated by said reproducing section to generate content information including information indicating that the specified broadcast program is already viewed.

12. A recording apparatus comprising:
recording means for recording a broadcast program including an image and voice on a recording surface of an optical disk;
obtaining means for obtaining program information relating to the broadcast program recorded by said recording means;
reading means for reading predetermined information from the optical disk on which the broadcast program is recorded;
generating means for generating content information indicating a content of the broadcast program recorded on the optical disk from program information obtained by said obtaining means and information read by said reading means; and
forming means for forming a visible image on a non-recording surface of the optical disk based on content information generated by said generating means.

13. A visible image forming method comprising:
recording a broadcast program including an image and voice on a recording surface of an optical disk;
obtaining program information relating to the broadcast program recorded by said recording;
reading predetermined information from the optical disk on which the broadcast program is recorded;
generating content information indicating a content of the broadcast program recorded on the optical disk from information read by said reading; and
forming a visible image on a non-recording surface of the optical disk based on content information generated by said generating.

14. A computer readable recording medium having a program recorded thereon, said program causing a computer to execute a visible image forming method comprising:
recording a broadcast program including an image and voice on a recording surface of an optical disk;
obtaining program information relating to the broadcast program recorded by said recording;
reading predetermined information from the optical disk on which the broadcast program is recorded;
generating content information indicating a content of the broadcast program recorded on the optical disk from program information obtained by said obtaining and information read by said reading; and
forming a visible image on a non-recording surface of the optical disk based on content information generated by said generating.

15. A computer data signal embedded in a carrier wave, representing a program for controlling a computer to execute:
recording a broadcast program including an image and voice on a recording surface of an optical disk;
obtaining program information relating to the broadcast program recorded by said recording;
reading predetermined information from the optical disk on which the broadcast program is recorded;
generating content information indicating a content of the broadcast program recorded on the optical disk from program information obtained by said obtaining and information read by said reading; and
forming a visible image on a non-recording surface of the optical disk based on content information generated by said generating.
